(19) United States
(12) Patent Application Publication
(10) Pub. No.: US 2009/0228476 A1
(43) Pub. Date: Sep. 10, 2009

(54) SYSTEMS, METHODS, AND SOFTWARE FOR CREATING AND IMPLEMENTING AN INTELLECTUAL PROPERTY RELATIONSHIP WAREHOUSE AND MONITOR

(76) Inventor: Marc Luther, Eagan, MN (US)

Correspondence Address: SCHWEGMAN, LUNDBERG & WOESSNER, P.A., P.O. BOX 2938, MINNEAPOLIS, MN, 55402, US

(21) Appl. No.: 12/341,944

(22) Filed: Dec. 22, 2008

Related U.S. Application Data
(60) Provisional application No. 61/008,826, filed on Dec. 21, 2007.

(51) Int. Cl. G06F 17/30

(52) U.S. Cl. 707/5; 707/E17.014

(57) ABSTRACT

An information retrieval system gathers intellectual property metadata based on a user query and a predetermined set of intellectual property databases, generating and rendering reports regarding intellectual property activities based on the user query.

### RELATED APPLICATION

The present application claims priority to U.S. Provisional Application 61/008,826 which was filed on Dec. 21, 2007 and which is incorporated herein by reference.

Additionally, the present application incorporates the following applications by reference: U.S. Provisional Applications 60/643,445 and 60/643,446, which were both filed on Jan. 12, 2005 and U.S. Utility application Ser. Nos. 11/331,409 and 11/332,783, which were both filed on Jan. 12, 2006.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2007, Thomson Reuters Global Resources.

### TECHNICAL FIELD

Various embodiments of the present invention concern information retrieval systems, particularly those that are tailored for particular industries, such as the legal industry.

### BACKGROUND

The practice of intellectual property (IP) law is demanding not only in terms of the time and skill required of the IP lawyers of who work in this field, but also in terms of the competition with other attorneys to perform efficient legal work for business clients across the country. In recent years, the competition for this work has stiffened as clients have sought cost savings by reducing the numbers of law firms they employ. Moreover, an apparent trend of law-firm consolidation, despite the fact that the number of patent and trademark application filings increase, has further heightened the general level of competition among law firms.

One problem the current inventor has recognized in the intellectual property legal area is that a significant amount of time is utilized researching, gathering and analyzing a company's intellectual property portfolio. Accordingly, the inventor has identified a need to provide comprehensive intellectual property data that intellectual property departments and firms can use to make better decisions regarding patent and trademark strategy.

### SUMMARY

To address this and/or other needs, the present inventor devised systems, methods, interfaces, and software that can discover, assess and analyze the patent and trademark filing activities of industries, companies, and filings related to particular attorneys/agents and law firms. Patent and trademark reports are generated and reflect recent activity in five areas: U.S. patents, U.S. patent applications, U.S. Granted patents, Patent Assignments, International Patents, PCT (Patent Cooperation Treaty) Applications, and Trademarks.

### BRIEF DESCRIPTION OF THE DRAWINGS

FIG. 1 is a block diagram of an exemplary information-retrieval system corresponding to one or more embodiments of the present invention.

FIG. 1a is an exemplary graphical user interface which corresponds to one or more embodiments of the present invention.

FIG. 2 is another exemplary graphical user interface which corresponds to one or more embodiments of the present invention.

FIG. 3 is another exemplary graphical user interface which corresponds to one or more embodiments of the present invention.

FIG. 4 is another exemplary graphical user interface which corresponds to one or more embodiments of the present invention.

FIG. 5 is another exemplary graphical user interface which corresponds to one or more embodiments of the present invention.

FIG. 6 is another exemplary graphical user interface which corresponds to one or more embodiments of the present invention.

FIG. 7 is flow chart of an exemplary method corresponding to one or more embodiments of the present invention.

FIG. 7a is another exemplary graphical user interface which corresponds to one or more embodiments of the present invention.

FIG. 8 is another exemplary graphical user interface which corresponds to one or more embodiments of the present invention.

FIG. 9 is another exemplary graphical user interface which corresponds to one or more embodiments of the present invention.

FIG. 10 is another exemplary graphical user interface which corresponds to one or more embodiments of the present invention.

FIG. 11 is another exemplary graphical user interface which corresponds to one or more embodiments of the present invention.

FIG. 12 is another exemplary graphical user interface which corresponds to one or more embodiments of the present invention.

FIG. 13 is another exemplary graphical user interface which corresponds to one or more embodiments of the present invention.

FIG. 14 is another exemplary graphical user interface which corresponds to one or more embodiments of the present invention.

FIG. 15 is another exemplary graphical user interface which corresponds to one or more embodiments of the present invention.

FIG. 16 is another exemplary graphical user interface which corresponds to one or more embodiments of the present invention.

FIG. 17 is another exemplary graphical user interface which corresponds to one or more embodiments of the present invention.

### DETAILED DESCRIPTION OF THE EXEMPLARY EMBODIMENT(S)

This description, which incorporates the Figures and the claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

Note that the features of various embodiments may be combined with features of other embodiments to yield other embodiments not expressly delineated as such.

### Exemplary Information-Retrieval System

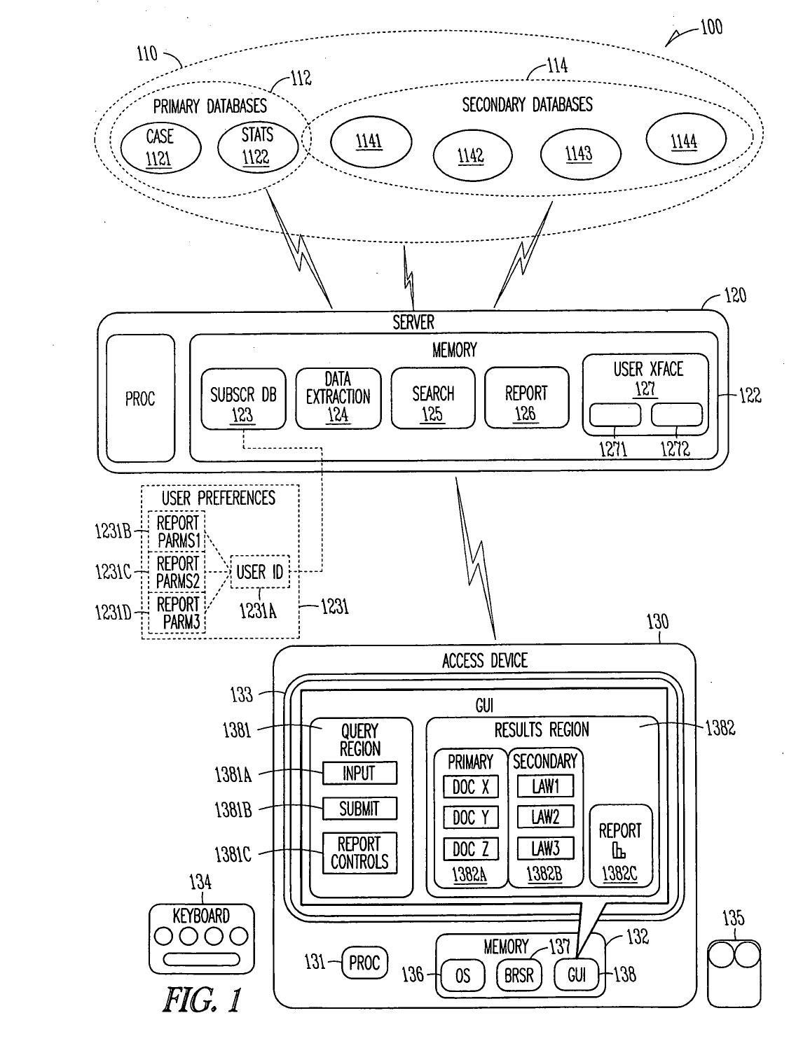

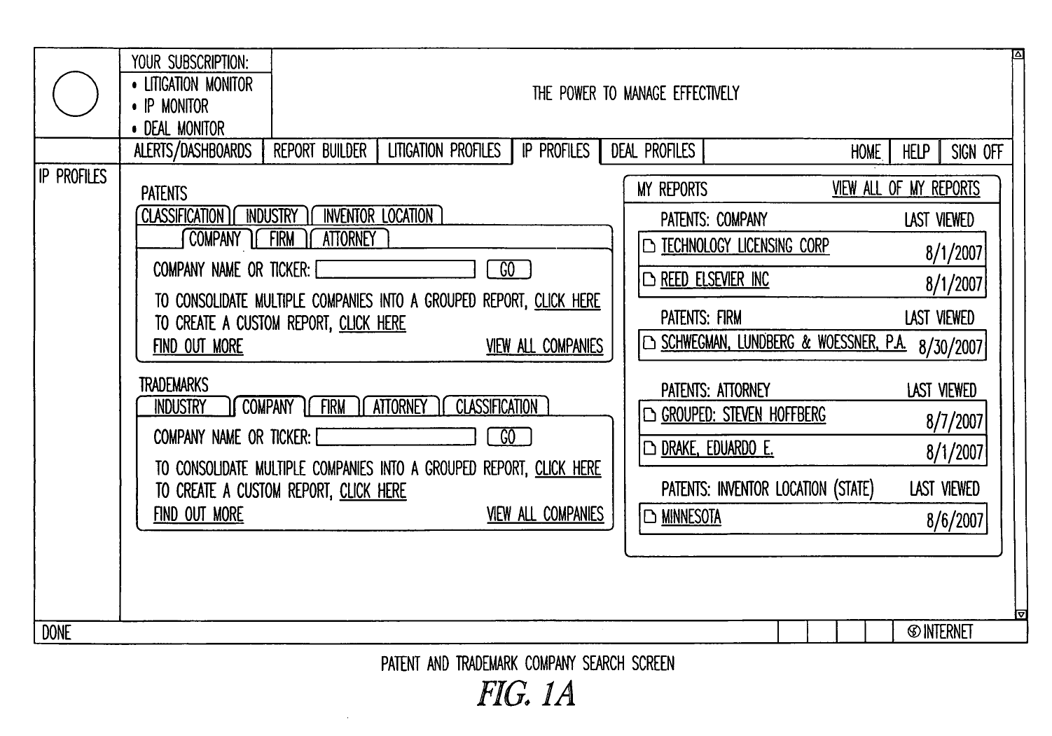

FIG. 1 shows an exemplary online information-retrieval system 100, which incorporates teachings of the present invention. System 100 includes one or more databases 110, one or more servers 120, and one or more access devices 130.

Databases 110 include a set of databases 112. Databases 112, in the exemplary embodiment, include a patent database 1121 and a trademark database 1122. More specifically, one set of databases includes one or more of the following types of content: issued patents, patent applications, patent assignments, international applications.

Each corporate profile includes one or more industry classification codes or indicators as well as associations to lawyer and law firm names derived from matching their names to those in documents containing references to both the corporate entity and the lawyer or law firm. In some embodiments, the intellectual property documents are logically associated via a data structure with documents or profiles in databases 112. Additionally, attorney or law firm profiles are associated with data structures that provide experiential ratings for the attorneys in the intellectual property field.

Databases 110, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 110 are coupled or couplable via a wireless or wireline communications network, such as a local-, wide-, private-, or virtual-private network, to server 120.

Server 120, which is generally representative of one or more servers for serving data in the form of webpages or other markup language forms with associated applets, ActiveX controls, remote-invocation objects, or other related software and data structures to service clients of various “thicknesses.” More particularly, server 120 includes a processor module 121, a memory module 122, a subscriber database 123, a data-extraction module 124, a search module 125, a report engine module 126, and a user-interface module 127.

Processor module 121 includes one or more local or distributed processors, controllers, or virtual machines. In the exemplary embodiment, processor module 121 assumes any convenient or desirable form.

Memory module 122, which takes the exemplary form of one or more electronic, magnetic, or optical data-storage devices, stores subscriber database 123, data-extraction module 124, search module 125, report engine module 126, and user-interface module 127.

Subscriber database 123 includes subscriber-related data for controlling, administering, and managing pay-as-you-go or subscription-based access of databases 110. In the exemplary embodiment, subscriber database 123 includes one or more report generation data structures, of which data structure 1231 is representative. Data structure 1221 includes a customer or user identifier portion 1231A, which is logically associated with one or more report generation or presentation preferences, such as preferences 1231B, 1231C, and 1231D. Preference 1231B includes a default value governing whether one of more of the functions described herein is enabled or disabled. Preference 1231C includes a default value governing presentation of interfaces related to the one or more functions. Preference 1231D includes a default value governing other aspects of the one or more functions. (In the absence of a temporary user override, for example, an override during a particular query or session, the default value for trend reporting govern.) In some embodiments, data structure 1231 stores parameters or filters for defining one or more trend reports.

Data-extraction module 124 includes one or more sets of machine-executable instructions for extracting patent numbers, patent titles, patent status, inventor names, inventor locations, trademark numbers, trademark status, attorney identification data, court and court date information, attorney plaintiff-defendant status information, client identification data, client industry identification data, client plaintiff-defendant status information, attorney-to-client identification data, and law-firm identification data from documents in databases 110.

In some embodiments, data-extraction module 124 produces a secondary index or other form of data structures which logically associates or relates documents and/or specific data contained in those documents to specific lawyers, law firms, patents, trademarks, assignments, companies, industries. In some embodiments, data-extraction module 124 includes separates sets of parsers and extractors tailored for various types of documents in database 110. Additionally, some embodiments employ simple text matching of lawyer and law firms names in attorney and law firm profiles or in corporate profiles to documents that are classified according to a patent/trademark classification hierarchy, whereas others employ complex Bayesian matching or other intelligent techniques for inferring such data connections.

In some embodiments, data extraction module 124 includes web-based applications to semantically connect or link a user to detailed information related to patent prosecution, trademark prosecution, an attorney's experience relating to intellectual property classifications, and assignments. In addition, some embodiments enable a user to automatically generate reporting data to determine attorneys' and/or firms' success records, law-firm trends and history in intellectual property law, and company/industry trends and histories with attorneys and firms who have represented them.

Search module 125 includes one or more search engines for receiving and processing user queries against one or more of databases 110. In the exemplary embodiment, one or more search engines associated with search module 124 enable users to search for attorneys, law firms patent/trademark classification, inventor location, companies or industries.

Report engine module 126 includes machine readable and/or executable instructions for generating and/or rendering interacting graphs based on data in databases 110 and trend report requests from a user. In the exemplary embodiment, module 126 includes instructions in accord with the report sections description and elsewhere in this document.

User-interface module 127 includes machine readable and/or executable instruction sets for wholly or partly defining web-based user interfaces, such as search interface 1271 and results interface 1272, over a wireless or wireline communications network on one or more accesses devices, such as access device 130.

Access device 130 is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 131 one or more processors (or processing circuits) 131, a memory 132, a display 133, a keyboard 134, and a graphical pointer or selector 135.

Processor module 131 includes one or more processors, processing circuits, or controllers. In the exemplary embodiment, processor module 131 takes any convenient or desirable form. Coupled to processor module 131 is memory 132.

Memory 132 stores code (machine-readable or executable instructions) for an operating system 136, a browser 137, and a graphical user interface (GUI) 138. In the exemplary embodiment, operating system 136 takes the form of a version of the Microsoft Windows operating system, and browser 137 takes the form of a version of Microsoft Internet Explorer. (However, some embodiments use other operating systems and browsers.) Operating system 136 and browser 137 not only receive inputs from keyboard 134 and selector 135, but also support rendering of GUI 138 on display 133. Upon rendering, GUI 138 presents data in association with one or more interactive control features (or user-interface elements). (The exemplary embodiment defines one or more portions of interface 138 using applets or other programmatic objects or structures from server 120 to implement the interfaces shown above or elsewhere in this description.)

More specifically, GUI 138 includes a query region 1381 and a results region 1382.

Query region 1381 includes an input feature 1381A, a submit feature 1381B, and a report control feature 1381C, which provides access to one or more other controls that enable a user to define and submit a trend report request. Input feature provides one or more input regions, such as a lawyer-law-firm selection feature, an inventor location selection feature, a company feature, an industry feature, and a patent/trademark classification feature. In the exemplary embodiment, each of these control features takes the form of a hyperlink or other browser-compatible command input, and provides access to and control of query region 1381 and search-results region 1382. User selection of the control features in region 1382 results in retrieval and display of at least a portion of the corresponding document within a region of interface 138 (not shown in this figure.) Although FIG. 1 shows region 1381 and 1382 as being simultaneously displayed, some embodiments present them at separate times.

### Exemplary Patent and Trademark Search Tab and Result GUIs

FIG. 1a shows the company search tab with the following text to the left of the search box: “Company Name or Ticker.” The following text displays below the search box: “To consolidate multiple companies into a grouped report, click here” and “To create a custom report, click here.” A user can create a custom report using a client-string that represents logical companies in the user's perspective. When the hyperlink to create a custom report is selected, the user can create a report using the Add or Delete functions. This creates a client string search definition. The custom search form must be available for searching on “client string.” A user selects the company name or the first three letters of the name. Additionally, the user has an option to view all companies located in an authority file using the View All Companies hyperlink. A company name or partial name in search field is entered. The search does a match on the three letters then matches the appropriate company names. Results of all companies with that word in their title are returned. A user clicks “GO” or presses the “Enter” key to initiate search. The entered text is used to match by “begins with” and “contains”. Noise words, multiple white space, and invalid characters are removed from the entered text. Search results are ordered by: “begins with” and “contains.”

FIG. 2 shows a list of all companies meeting the search criteria, that is, the search results. The report displays the following text: “The following reports match your current search criteria. You may click on the report title to view it. Check the boxes and click “Group” button to consolidate multiple companies into a grouped report.” The “Group” button is displayed on company search results tab when the list displays. A “Search Again” link is displayed to begin a new search from the homepage. Furthermore, the event count for the company (the count for the last five years—updated every 24 hours) is also displayed. The following metadata is listed for a company:
Canonical Name—linked to the patent profile report
Company Address
Company URL (not an active link)
Related Industry—linked to the industry search result for the industry for which this company was classified

The Table of Contents for a Company Patent Report includes the following sections: Overview; Company Name Variants; U.S. Classification; International Classification; Locarno Classification; Derwent Classification; Buyers and Sellers; Patents by Country; Patents in Litigation; Law Firm Analysis; Attorney Analysis; Inventor Location; and Document Match List. The Table of Contents for a Company Trademark Report includes the following sections: Overview; Industry; Company Name Variants; Trademark Classification; Trademark Status; Law Firm Analysis; Attorney Analysis; and Document Match List.

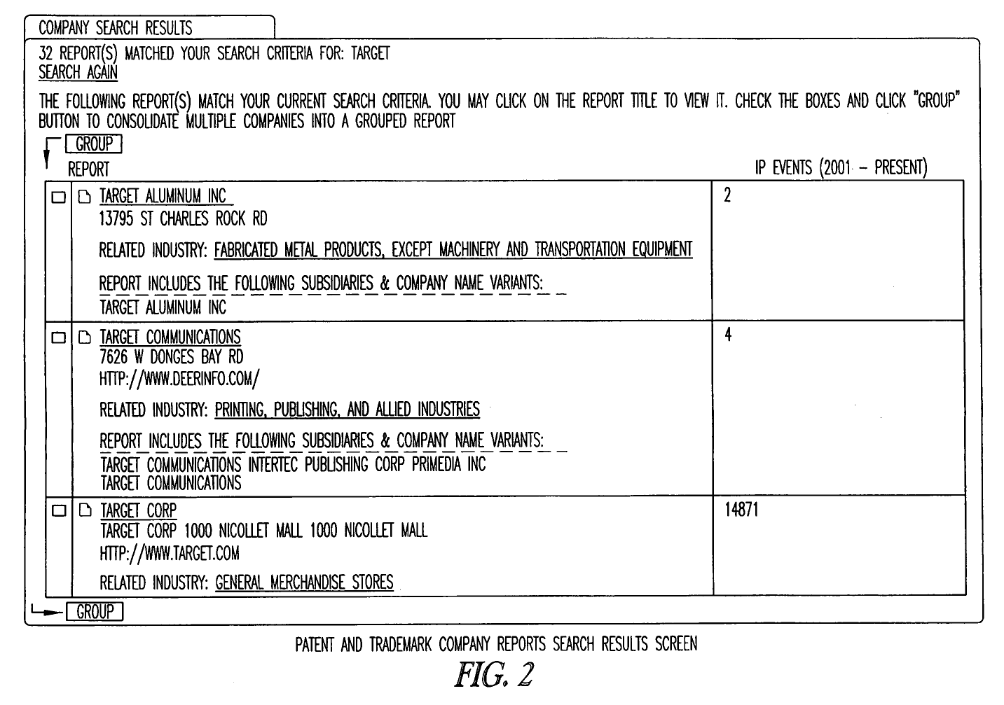

FIG. 3 shows the industry search tab with the following text: “To search for an industry, select an industry from the pull-down menu and click the “Go” button. To browse all industries click the View All Industries link.” A may select a specific industry for the report or search using hyperlink named “View All Industries”. When “View all Industries” is selected, all industries are displayed with the number of events found for each industry and can be selected from a drop down menu. The user clicks “GO” or presses the “Enter” key to create a report.

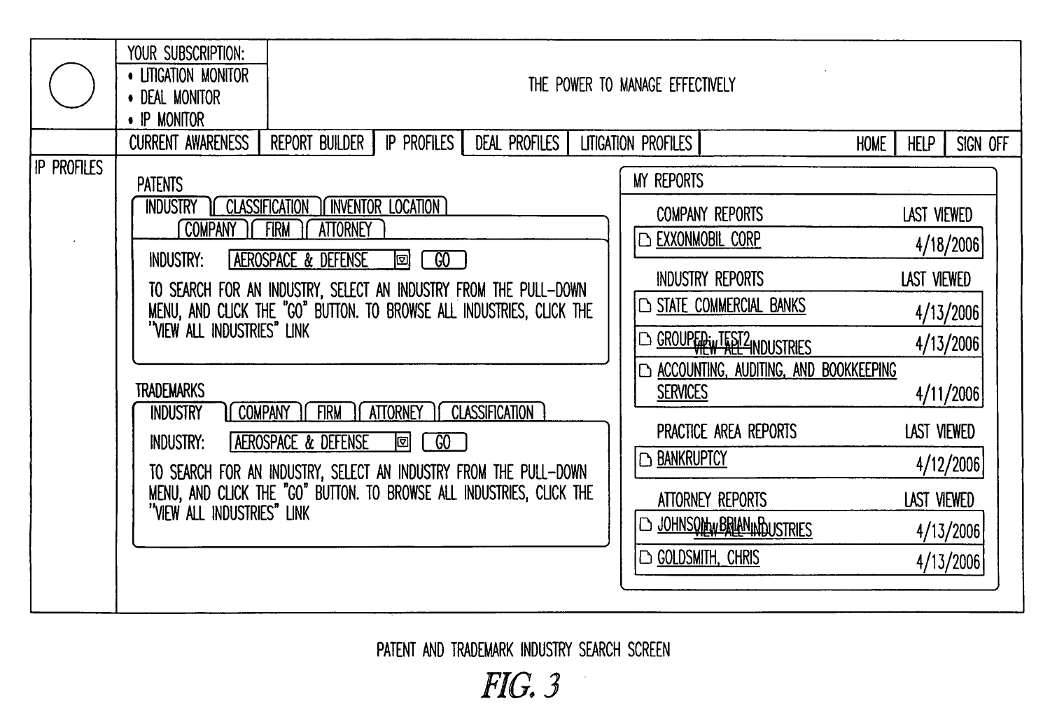

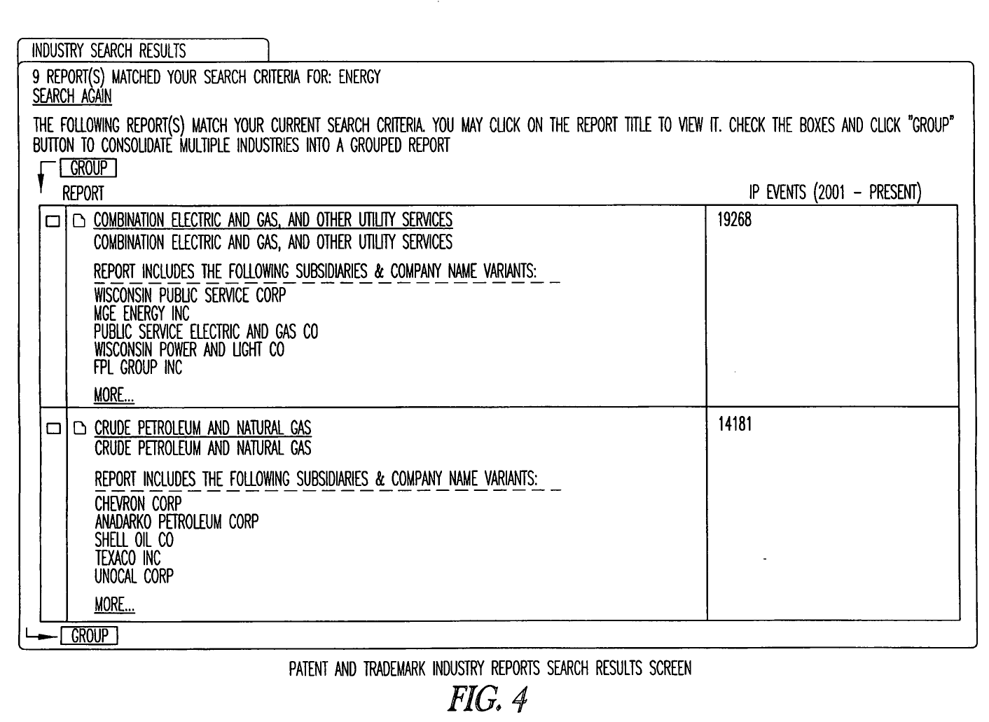

FIG. 4 shows the industry search results with the following text at the top of the search results page: “{number of results} report(s) matched your search criteriafor {Industry name}.” Display text on Search Results: “The following reports match your current search criteria. You may click on the report title to view it. Check the boxes and click “Group” button to consolidate multiple companies into a grouped report.” Industry search results page shows the total number of reports and events available for the selected industry. A user has the option to group selected industries into one report. Furthermore, the user could click on “More” link to view all companies belonging to the selected industry. Clicking on a selected industry generates a full report.

The Table of Contents for an Industry Patent Report includes the following sections: Overview; Company Analysis; U.S. Classification; International Classification; Locarno Classification; Derwent Classification; Buyers and Sellers; Patents by Country; Patents in Litigation; Law Firm Analysis; Attorney Analysis; Inventor Location; and Document Match List. The Table of Contents for an Industry Trademark Report includes the following sections: Company; Trademark Classification; Trademark Status; Law Firm Analysis; Attorney Analysis; and Document Match List.

FIG. 5 shows the law firm search tab with the following text to the left of the search box “Firm Name:” and the following text “To search for a law firm, type the firm's name and click the “Go “button. If you're not sure how a law firm is identified, you can type a name or the first three letters of their name and click the “Go” button.” A user enters a complete or partial law firm name in search field (must be at least 3 characters in length). The search on a name returns results of all law firms with that word in their title. A search for law firm using entered text is used to match by “begins with” and “contains.” Noise words, multiple white space, and invalid characters are removed from the entered text. Search results are ordered by: “begins with” and contains.” The user clicks “GO” or presses the “Enter” key to create a report.

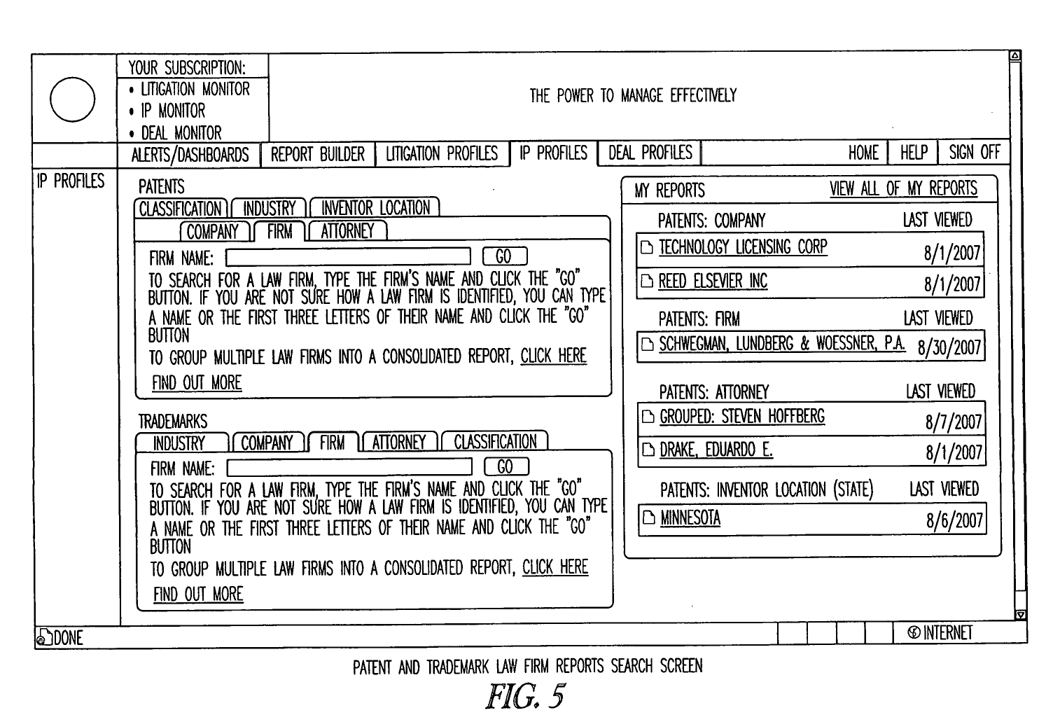

FIG. 6 shows the law firm results with the following text at the top of the search results page: “{number of results} report(s) matched your search criteria for {law firm name}” and the following text “The following reports match your current search criteria. You may click on the report title to view it. Check the boxes and click “Group” button to consolidate multiple law firms into a grouped report.” Furthermore, this section displays a list of all law firms, branch names, and addresses (if applicable) meeting the search criteria and the total number of events for each law firm. The user clicks on the link for the selected law firm to generate a report. There is an option to group multiple firms into one consolidated report. Law Firm Search Results page should display total number of IP Events found. The “Group” button appears on a law firm search results tab when the list is displayed.

The following metadata is displayed for a law firm:
Canonical Name—linked to the IP Monitor report
Law Firm address
TLR Profile/Listing (via an active link)
   If applicable, display the following text: “This lawfirm has the following branch(s)” and list of all branch offices and addresses” and the event count for the law firm (the count for the last five years—updated every 24 hours). A user can group the selected law firms into one report. A link to “Search Again” is displayed to begin new search from the homepage.
   The report includes sections with selected reports by the following content:
Introduction
Display Law Firm Name
Address
URL

The Table of Contents for a Law Firm Patent Report includes the following sections: Company Analysis; Industry; U.S. Classification; International Classification; Locarno Classification; Derwent Classification; Buyers and Sellers; Patents by Country; Patents in Litigation; Attorney Analysis; Inventor Location; and Document Match List. The Table of Contents for a Law Firm Trademark Report includes the following sections: Industry; Company; Trademark Classification; Trademark Status; Attorney Analysis; and Document Match List.

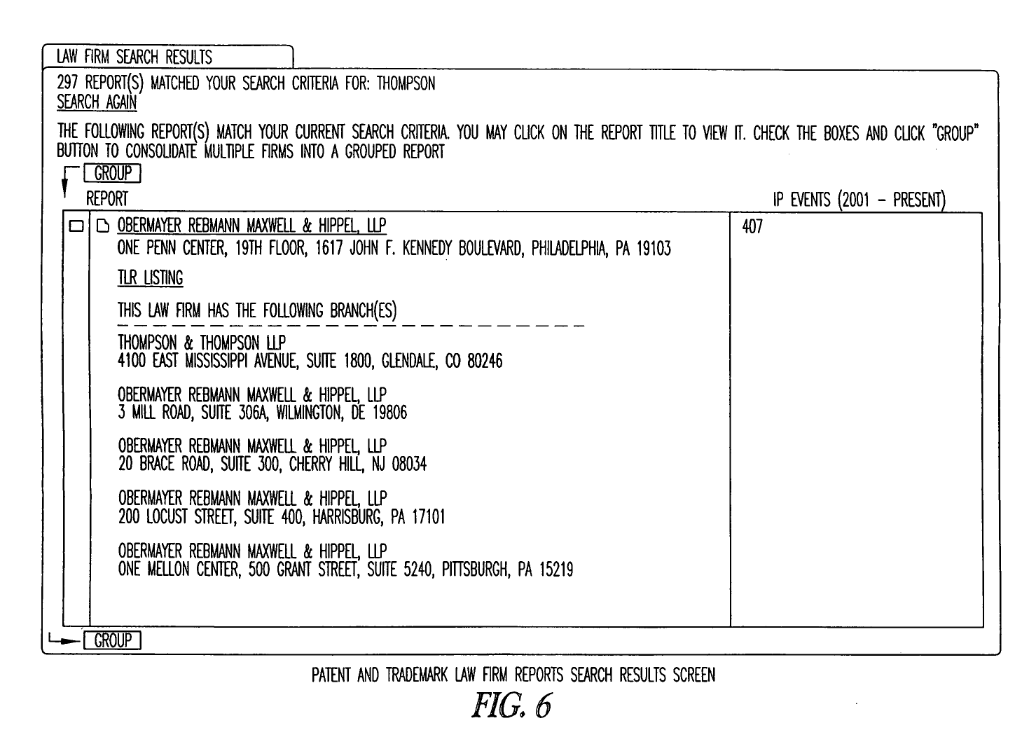

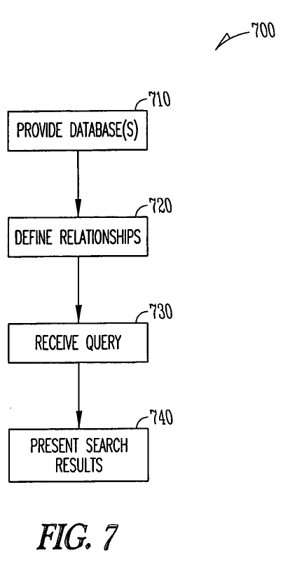

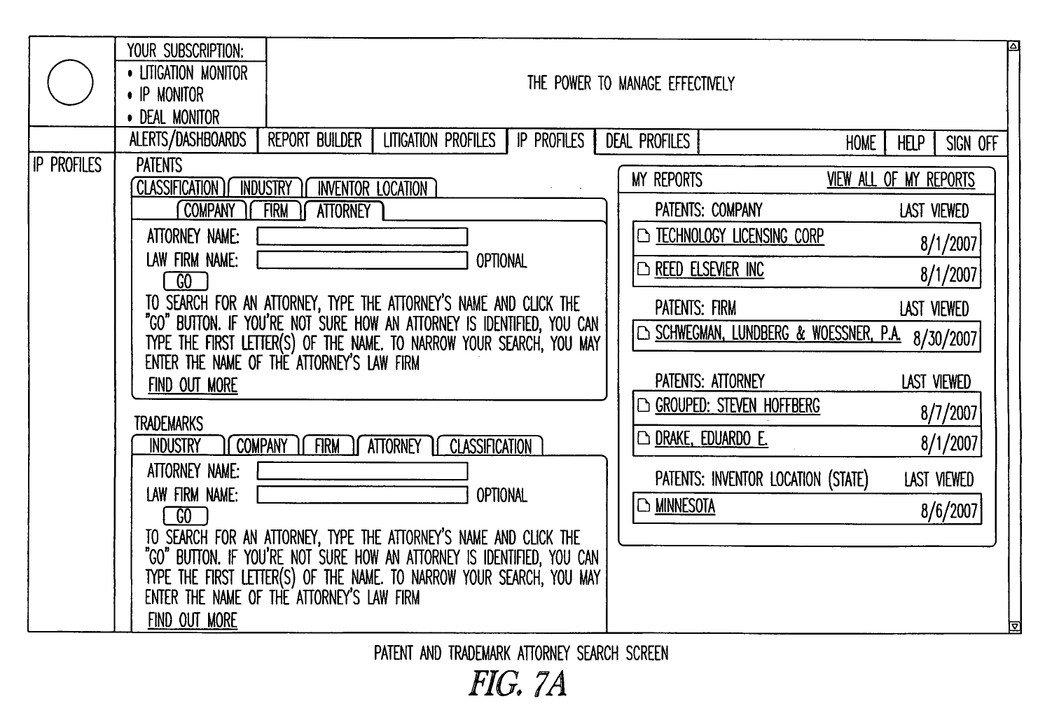

FIG. 7a shows the attorney search tab with the following text “To search for an attorney, type the attorney's name and click the “Go” button. If you're not sure how an attorney is identified, you can type the first letter(s) of the name. To narrow your search you may enter the name of the attorney's law firm.” and the following text to the left of the search boxes “Attorney Name.” and “Law Firm Name.” The text “Optional” is displayed to the right of the law firm search box. A user has options to search for an attorney by name or first three letters of the name. In addition to the search options previously named, the user can optionally enter and search by law firm at which the attorney works. When the hyperlink to create a custom report is selected, the user creates a report using the Add or Delete functions. This creates a client string search definition. The user selects the attorney name or first three letters of the name. Then the user clicks “GO” or presses the “Enter” key to create a report.

FIG. 8 shows the attorney search results with the following text at the top of the search results page: “{number of results} report(s) matched your search criteria for {attorney name}” and the following text: “The following reports match your current search criteria. You may click on the report title to view it. Check the boxes and click “Group” button to consolidate multiple attorneys into a grouped report.” A user clicks on the link for the selected attorney to generate a full report. Attorney search results page displays the total number of events for each attorney. Attorney search results display a link to the Thomson Legal Profile/Listing application through the TLR Listing hyperlink. There is an option to group selected attorneys into one report. A link to “Search Again” is displayed to begin new search from the homepage.

The Table of Contents for an Attorney Patent Report includes the following sections: Company Analysis; Industry; U.S. Classification; International Classification; Locarno Classification; Derwent Classification; Buyers and Sellers; Patents by Country; Patents in Litigation; Law Firm Analysis; Inventor Location; and Document Match List. The Table of Contents for an Attorney Trademark Report includes the following sections: Industry; Company; Trademark Classification; Trademark Status; Law Firm Analysis; and Document Match List.

FIG. 9 shows the patent classification search tab with the following text: “To search for a classification type, select taxonomy from the drop down menu. Select a classification code or name using the search box below. To view all US, International, Locarno or Derwent classifications, click the “View All Top Level Classifications” link.” and the text labels to the left of each drop down list: “Taxonomy:” and “Classification Code or Name.” The list of classifications are displayed in hierarchical order by top level down to the sub-classification level, and located below the introductory paragraph. A user has an option to select a specific taxonomy and classification code for their report or to search using hyperlink to “View All Top Level Classifications.” The user enters a number or text in the lower drop-down search box (classification code or name) and is directed to the first corresponding number or letter using a “search and scroll” function. The drop down menu displays all available classification codes and names that begin with or contain the entered text. The second level search results are displayed in caps and not in bold. The user clicks on a classification name or code to select it and create a full report. When “View all Classifications” is selected all classifications are displayed and listed as US classification, international classification, Locarno classification and Derwent classification. A user may select a taxonomy classification (US, International, Locarno or Derwent) from the first drop down menu and then select a classification code or name from the second drop down menu. The user clicks “GO” or presses the “Enter” key to initiate search.

A user clicks on the name of a specific classification to generate a full report. The total number of events for each classification is displayed. If no events exist for a classification, no results are displayed. The full classification report includes sections that can be refocused using second level classifications. The report includes sections with selected reports by the following content:
Introduction
Display Classification Name

The Table of Contents for a Classification Patent Report includes the following sections: Company; Industry; U.S. Classification; International Classification; Locarno Classification; Derwent Classification; Buyers and Sellers; Patents by Country; Patents in Litigation; Law Firm Analysis; Attorney Analysis; Inventor Location; and Document Match List.

FIG. 10 shows the trademark classification search tab with the following text: “To search for a Classification, select a Classification from the pull-down menu, and click the “Go” button. To browse all Classifications, click the “View All Classifications” link.” and the text label to the left of each drop down list: “Classification.” A user may select a specific classification for their report or search using the hyperlink to “View All Classifications.” When “View all Classifications” is selected, all trademark US classifications are displayed and selected from a drop down menu. The user clicks “GO” or presses the “Enter” key to create a full report

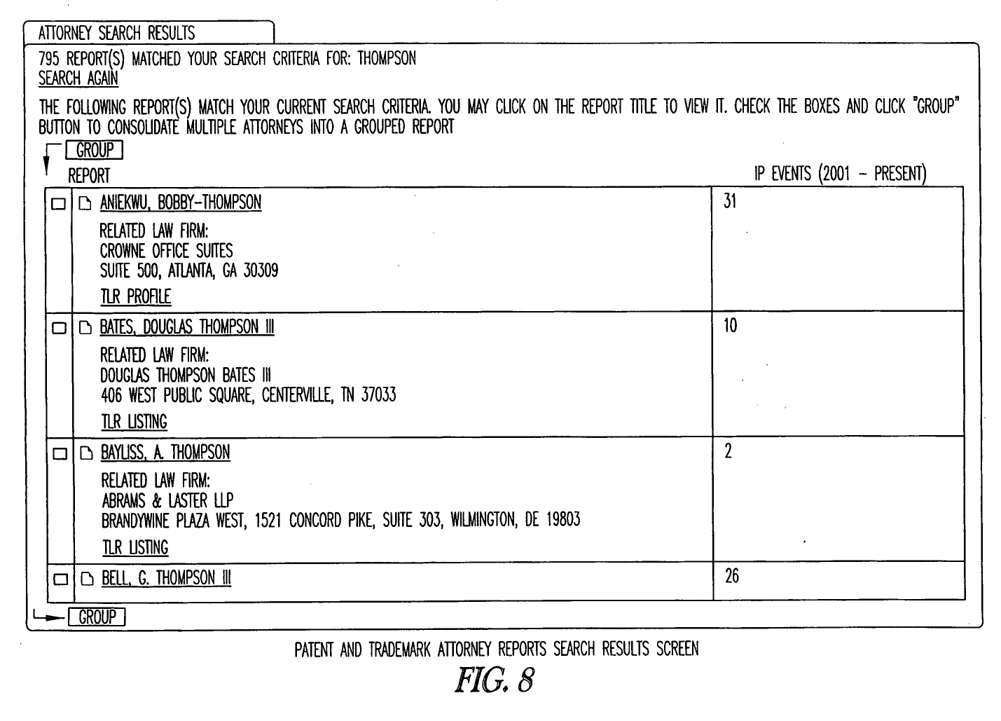

In FIG. 11, the user clicks on a specific trademark classification to generate a report. The total number of events for each classification is displayed. A user can click on the link of the selected classification to generate an event report. Classification reports show events from {Month, YYYY} through {Month, YYYY} (per current focus). When “View all Classifications” is selected, all trademark classifications must be displayed with any sub-categories that contain events listed beneath.

The Table of Contents for a Classification Trademark Report includes the following sections: Industry; Company; Trademark Status; Law Firm Analysis; Attorney Analysis; and Document Match List.

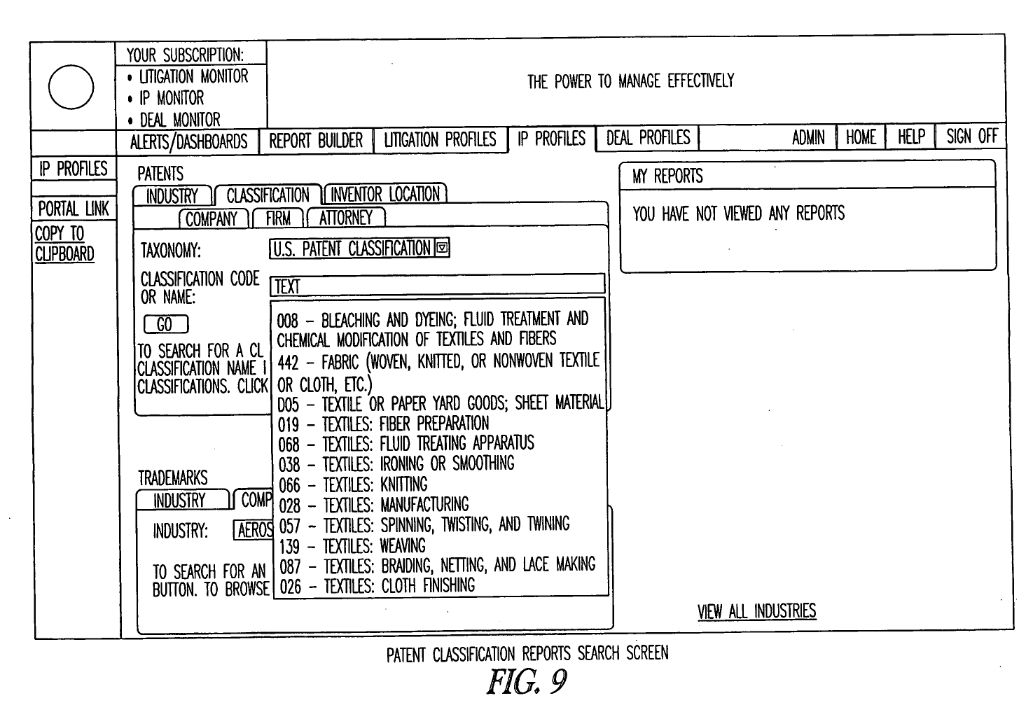

FIG. 12 shows the inventor location search tab with the following text: “To view an Inventor Location report, select a sate or country from the applicable pull-down menu and click the “Go” button. To browse all available states and countries click the “View all Locations” link.” There are options to select a specific location by either state or country or use a link to “View All Locations.” The text labels to the left of each drop down list indicate “State:” and “International.” When “View all Locations” is selected, all locations must be displayed by state and international and with the total event count displayed for that location. A selection is chosen from the drop down menu. The user clicks “GO” or presses the “Enter” key to initiate search.

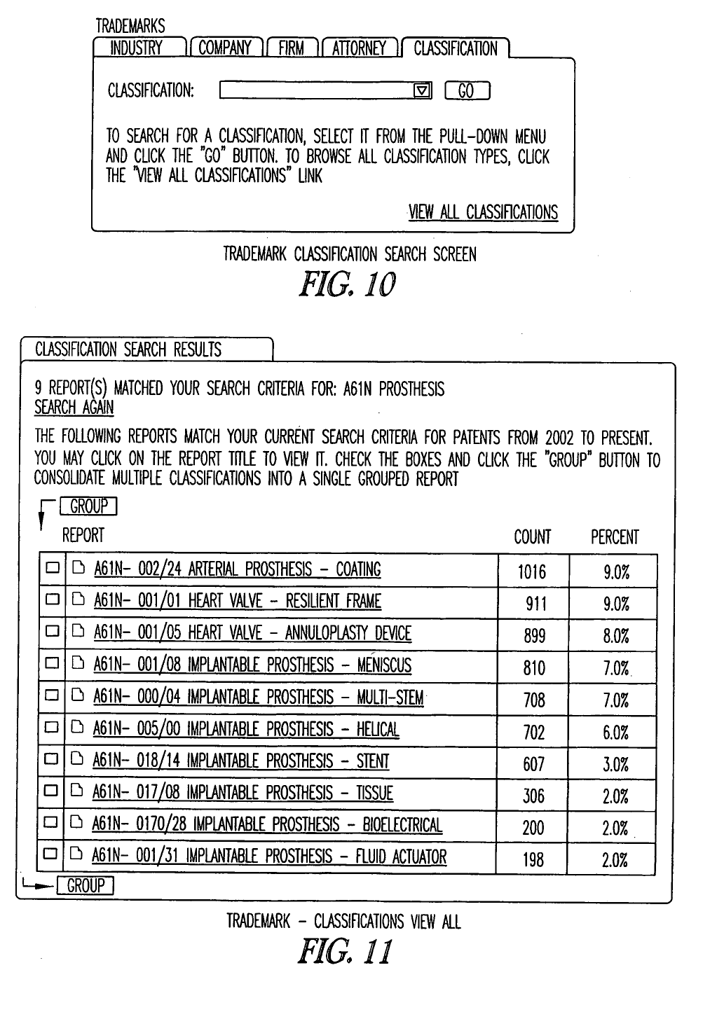

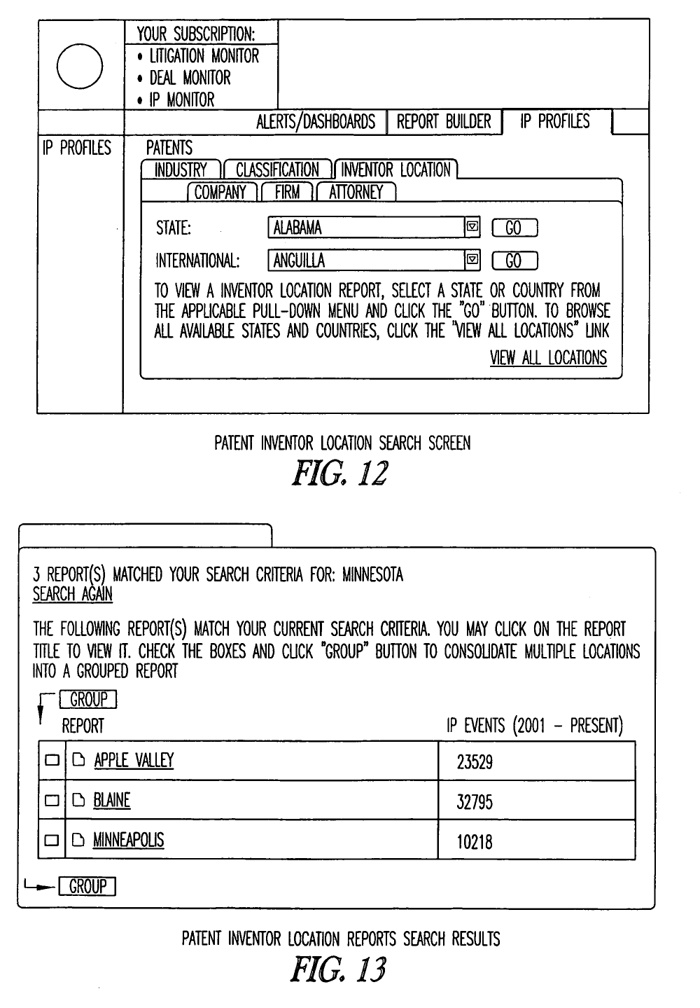

FIG. 13 shows the inventor location search results with the following text at the top of the search results page: “{number of results} report(s) matched your search criteria for {location}.” and “The following report(s) matched your current search criteria. You may click on the report title to view it. Check the boxes and click “Group” button to consolidate multiple locations into a grouped report.” When the user selects a specific state or country, a complete report is created. The “Group” button is displayed on inventor location search results tab when the list is displayed. Each state name has the number of events located in the right hand column.

The Table of Contents for an Inventor Location Patent Report includes the following sections: Company; Industry; U.S. Classification; International Classification; Locarno Classification; Derwent Classification; Buyers and Sellers; Patents by Country; Patents in Litigation; Law Firm Analysis; Attorney Analysis; and Document Match List.

### Patent and Trademark Report Sections

The overview section for patents shows the following data: U.S. patents and U.S. patent applications. In addition, the patent overview section shows a pie chart and graph showing patents acquired/granted and sold/expired and current patent applications along with their status. The overview section for trademarks shows the following data: US trademarks and US trademark applications. In addition, the trademark overview section includes a pie chart and graph showing: trademarks acquired/granted and sold/expired and current trademark applications along with their status. Each display refocuses the report by clicking on an area of the pie chart or highlighted name on the analysis list. The company section should include the options to view “Full List and Advanced Features” and/or “Description of Sources for this Report” and display a link to return to “Table of Contents.” Event counts are not displayed in this section.

The company name variant section displays a heading “Company Name Variants” and a canonical name heading for the section—all caps. Each analysis list item displays as a link and refocuses the entire section on just the data constrained to that analysis item. This list represents and displays up to the top ten variants ordered by descending event count. Two or more than ten event counts are aggregated and displayed by count and percentage in the last row. The report may be drilled down and refocused by clicking on a company name link. Individual items aggregated into the last row are viewed using the “Full List and Advanced Features.” The company variant section should include the options to view “Description of Sources for this Report” and display a link to return to “Table of Contents.” The report contains the current list of criteria and displays a heading “Report Criteria.”

The company section for patents displays one pie chart section showing all patent activities sorted by: U.S. patents and U.S. patent applications. Another pie chart and graph shows patent activities sorted by: patents acquired/granted and sold/expired. The company section for trademarks displays a pie chart and graph showing all trademarks that have originated with this company and/or that have been acquired by this company. The analysis list heading is “Companies.” This list represents and displays up to the top ten companies ordered by descending event count. Two or more than ten event counts are aggregated and displayed by count and percentage in the last row. The report may be drilled down and refocused by clicking on an area of the pie chart, highlighted name on the table or company name link. The company section should include the options to view “Full List and Advanced Features” and/or “Description of Sources for this Report” and display a link to return to “Table of Contents” and/or “Number of Patent Activities.”

The industry section displays pie charts showing the Classification Distribution related to this topic in the following order: U.S. Patents and U.S. Patent Applications. The analysis list heading is “Industry.” This list represents and displays up to the top ten industries ordered by descending event count. Two or more than ten event counts are aggregated and displayed by count and percentage in the last row. The report may be drilled down and refocused by clicking on an area of the pie chart, highlighted name on the table or industry name link. The industry section should include the options to view “Full List and Advanced Features” and/or “Description of Sources for this Report” and display a link to return to “Table of Contents.”

The patent classification section displays pie charts and graphs of all classifications within the selected US Classification taxonomy. The analysis list heading is “US Classifications.”This list represents and displays up to the top ten classifications ordered by descending event count. Two or more than ten event counts are aggregated and displayed by count and percentage in the last row. The report may be drilled down and refocused by clicking on an area of the pie chart, highlighted name on the table or US classification name link. The classification section should include the options to view “Full List and Advanced Features” and/or “Description of Sources for this Report” and display a link to return to “Table of Contents.”

The international classification section displays pie charts and graphs of all classifications within the selected international taxonomy. The analysis list heading is “International Classifications.” This list represents and displays up to the top ten classifications ordered by descending event count. Two or more than ten event counts are aggregated and displayed by count and percentage in the last row. The report may be drilled down and refocused by clicking on an area of the pie chart, highlighted name on the table or international classification name link. The international classification section should include the options to view “Full List and Advanced Features” and/or “Description of Sources for this Report” and display a link to return to “Table of Contents.”

The Locarno classification section displays pie charts and graphs of all classifications within the selected Locarno taxonomy. The analysis list heading is “Locarno Classifications.” This list represents and displays up to the top ten classifications ordered by descending event count. Two or more than ten event counts are aggregated and displayed by count and percentage in the last row. The report may be drilled down and refocused by clicking on an area of the pie chart, highlighted name on the table or Locarno classification name link. The Locarno classification section should include the options to view “Full List and Advanced Features” and/or “Description of Sources for this Report” and display a link to return to “Table of Contents.”

The Derwent classification section displays pie charts and graphs of all classifications within the selected Derwent taxonomy. The analysis list heading is “Derwent Classifications.” This list represents and displays up to the top ten classifications ordered by descending event count. Two or more than ten event counts are aggregated and displayed by count and percentage in the last row. The report may be drilled down and refocused by clicking on an area of the pie chart, highlighted name on the table or Derwent classification name link. The Derwent classification section should include the options to view “Full List and Advanced Features” and/or “Description of Sources for this Report” and display a link to return to “Table of Contents.”

The trademark classification section displays pie charts and graphs of all classifications within the selected trademark taxonomy. The analysis list heading is “Trademark Classifications.” This list represents and displays up to the top ten trademark classifications ordered by descending event count. Two or more than ten event counts are aggregated and displayed by count and percentage in the last row. The report may be drilled down and refocused by clicking on an area of the pie chart, highlighted name on the table or trademark classification name link. The trademark classification section should include the options to view “Full List and Advanced Features” and/or “Description of Sources for this Report” and display a link to return to “Table of Contents.”

The trademark status section shows a graph showing the status of each trademark. Clicking on the chart or listing criteria re-focuses and targets the report by companies. The analysis list heading is “Trademark Status.” This list represents and shows the types of trademark status ordered by descending event count. The event counts are aggregated and displayed by count and percentage. The report may be drilled down and refocused by clicking on trademark status name link. The trademark status section should include the options to view “Description of Sources for this Report” and display a link to return to “Table of Contents.”

The buyer and seller section shows fields in the following order: assignees and subsidiary companies (companies selling patents); assignors and subsidiary companies (companies buying patents). The analysis list heading is “Buyers and Sellers.” This list represents and displays up to the top ten buyers and sellers ordered by descending event count. Two or more than ten event counts are aggregated and displayed by count and percentage in the last row. The report may be drilled down and refocused by clicking on a buyer or seller name link. The buyer and seller section should include the options to view “Full List and Advanced Features” and/or “Description of Sources for this Report” and display a link to return to “Table of Contents.”

The patents by country section displays a pie chart and graph showing and sorting the granted patents by location. The analysis list heading is “Patents by Country.” This list represents and displays up to the top ten countries ordered by descending event count. Two or more than ten event counts are aggregated and displayed by count and percentage in the last row. The report may be drilled down and refocused by clicking on an area of the pie chart, highlighted name on the table or a country name link. The patents by country section should include the options to view “Full List and Advanced Features” and/or “Description of Sources for this Report” and display a link to return to “Table of Contents.”

The law firm section for patents displays a pie chart and graph of patent activities of law firms in US patent applications and US granted patents. The law firm section for trademarks, the section displays law firms performing trademark legal works. The analysis list heading is “Law Firm.” This list represents and displays up to the top ten law firms ordered by descending event count. Two or more than ten event counts are aggregated and displayed by count and percentage in the last row. The report may be drilled down and refocused by clicking on a law firm name link. The law firm section should include the options to view “Full List and Advanced Features” and/or “Description of Sources for this Report” and display a link to return to “Table of Contents.”

The attorney section for patents displays a pie chart and graph of patent activities of attorneys in US patent applications and US granted patents. The attorney section for trademarks, the section displays attorneys performing trademark legal works. The analysis list heading is “Attorneys.” This list represents and displays up to the top ten attorneys ordered by descending event count. Two or more than ten event counts are aggregated and displayed by count and percentage in the last row. The report may be drilled down and refocused by clicking on an attorney name link. The attorney section should include the options to view “Full List and Advanced Features” and/or “Description of Sources for this Report” and display a link to return to “Table of Contents.”

The inventor location section displays a pie chart and graph of all inventors sorted by state and international locations. The analysis list heading is “Inventor Locations.” This list represents up to the top ten locations ordered by descending event count. Two or more than ten event counts are aggregated and displayed by count and percentage in the last row. The report may be drilled down and refocused by clicking on a location name link. In addition, this section includes a multi-level reporting structure. The inventor location section should include the options to view “Full List and Advanced Features” (expanded version of the existing table) and/or “Description of Sources for this Report” and display a link to return to “Table of Contents.”

The patents in litigation section displays a table of patents which the user may sort in this table only (twenty most recent) by clicking on any heading. This section includes: Case Filed; Patent No. (contains link to Westlaw); U.S. Classification; Patent Title; Patent Firm; Plaintiff; Plaintiff Firm; Defendant; Defendant Firm; Court; and Docket No. (contains link to Westlaw). The twenty most recent patents in litigation are displayed. Twenty-one or more are displayed in the twenty-first row with the label “Other Patents.” The patents in litigation section should include the options to view “Full List and Advanced Features” (expanded version of the existing table) and/or “Description of Sources for this Report” and display a link to return to “Table of Contents.”

The document match list section displays text: “Latest {XXX} of {XXX} . . . matching your current criteria” and the twenty most recent documents. Twenty-one or more are displayed in the twenty-first row indicated as “Other.” This section includes the option to view “Description of Sources for this Report.” Scrolling applies if necessary. The document match list includes link to abstract through the application.

Patent fields are sorted by assignee and date. Display fields include: Title; US Patent Number; Type of Document (Patent or Application); Assignee; Date (dependent on document type); Application Date; and Patent Date.

Trademark fields are sorted by date filed and assignee (company). Display fields include: Title; Serial No.; USPTO Status; USPTO Status Date; and Classification.

A user has the ability to select and download the report output in pdf format. In addition, the user can define the date range for the report. All charts and graphs represent the colors and data found in the table in the same order.

Thomson West retrieves information about U.S. Patents, Patent Applications, Patent Assignments and International Patents from Westlaw® documents, as follows: United States Patents—patents issued by the U.S. Patent and Trademark Office (USPTO) since 1976; United States Patent Applications—patent applications published by the U.S. Patent and Trademark Office (USPTO) beginning with March 2001; United States Patent Assignments—patent assignments recorded with the U.S. Patent and Trademark Office (USPTO) since 1980; International Patents—as derived from Derwent World Patents describing where patents are issued worldwide from over 40 international authorities, from 1963 to present.

Thomson West retrieves information about U.S. Trademarks, Trademark Applications, and Trademark Assignments from Westlaw® documents, as follows: United States Trademarks—as derived from TRADEMARKSCAN®, trademarks registered with the U.S. Patent and Trademark Office (USPTO) since 1984; United States Trademark Applications—as derived from TRADEMARKSCAN®, actual use and intent to use, trademark applications filed with the U.S. Patent and Trademark Office (USPTO) since 1984; United States Trademark Assignments—trademark assignments recorded with the U.S. Patent and Trademark Office (USPTO) since 1984.

A user can view the names and description of all sources for the selected reports. In addition, the user can click on and display the entire Description of Sources and this link is located at the bottom of the list.

A user can refocus a report from the currently viewed section. In addition, multiple items (companies, industries, etc.) can be selected in a section in order to refocus the report. The user can print the report from this screen, save the defined report criteria for future use, or apply saved criteria to any applicable report. All saved criteria can be removed. Access to the above functions is available at the section level of a profile application. The criteria and date range are displayed. The user has options to print the report from this profile panel and to include or exclude the selected items on the first screen.

In FIG. 1a, a user views all reports created or refreshed in the last 6 months. The default view is limited in the exemplary embodiment to the last four viewed of each report type and listed in the same order as seen on the tabs. A user clicks on and displays all the data found in each report. Grouped reports are listed with “Grouped” as prefix in title. Custom reports are listed with “Custom” as prefix in the title and are under the “Company” heading. There is an option to delete the reports. A user must be able to access the above functions at the home page of the application with a last viewed date being displayed.

When filtering report criteria, report displays headings “Report Criteria,” “Company,” and “Date Range.” A user views the entity name and date range for the selected report. The name of each criteria used to filter the report is listed, with an option to delete it from the report. In addition, each criterion can be drilled down into the report details. A user can view this data at the bottom of each section in the total report. The following may be used as report filters: Date Range; Document Type; Industry; Law Firm; Attorney; Company; U.S. patent Classification; International Patent Classification; Trademark Classification; Country Location; and Buyers and Sellers.

FIG. 14 shows an alert screen that allows the user to be notified when there are updates from a source field. Each field must contain a checkbox for selection purposes. Each source field must contain an Edit link to open source for editing email address or check box to “email me to notify of “no results”.

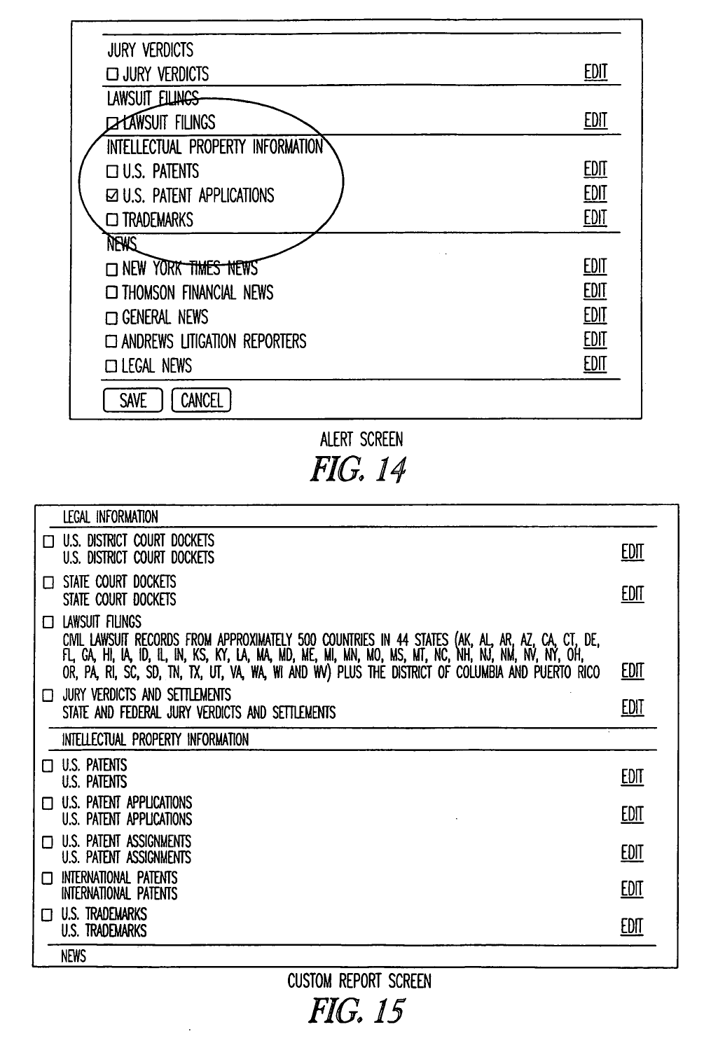

FIG. 15 shows another embodiment of the present invention that allows the user to create a custom report. Each field contains a checkbox for selection purposes. Each source field contains an Edit link to open source to edit date range and restriction through the use of a drop-down box. FIG. 16 shows the date range for custom reports ranges from today to “Most recent 2 years” (default value).

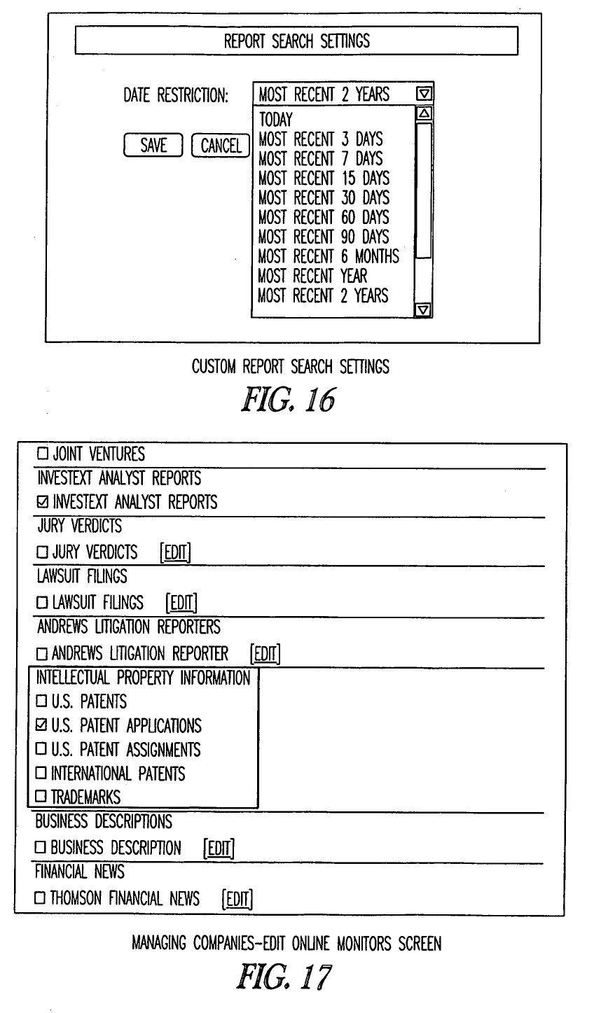

FIG. 17 shows an edit online monitor screen available under the Mange My Companies link. Each field contains a checkbox for selection purposes. Some source fields contain an Edit link to open source to edit through the use of a drop-down box.

User will be able to create Alerts using the following data sources:

| Data | Signon |
|---|---|
| Patents | US-PAT |
| Patent Applications | US-PAT-APP |
| Trademark info | FED-TM |

Alert Queries

| | |
|---|---|
| US-PAT | PAS(CompanyName) % CI(APP) |
| US-PAT-APP | PAS(CompanyName) |
| FED-TM | ON(CompanyName) |

Monitor Queries

| | |
|---|---|
| US-PAT | PAS(CompanyName) % CI(APP) |
| US-PAT- | ((PAS(CompanyName) PASR(CompanyName))) % |
| ASSIGN | “ASSIGNMENT OF ASSIGNORS INTEREST” |
| US-PAT-APP | PAS(CompanyName) |
| FED-TM | ON(CompanyName) |
| DWPL | PAS(CompanyName) |

User will be able to create reports using the following data sources:

| Data | Signon |
|---|---|
| Patents | US-PAT |
| Patent Applications | US-PAT-APP |
| Patent Assignments | US-PAT-ASSIGN |
| International Patents | DWPL |
| Trademark Info | FED-TM |

Queries used to define the fields for creating reports will be queried as follows:

| | |
|---|---|
| US-PAT | PAS(CompanyName) & DA( ) % CI(APP) |
| US-PAT- | ((PAS(CompanyName) PASR(CompanyName)) & |
| ASSIGN | DA( ) % |
| | “ASSIGNMENT OF ASSIGNORS INTEREST” |
| US-PAT-APP | PAS(CompanyName) & DA( ) |
| FED-TM | ON(CompanyName) & DA( ) |
| DWPL | PAS(CompanyName) & DA( ) |

### Exemplary Methods of Operating an Information-Retrieval System

FIG. 7 shows a flow chart 700 of an exemplary method of operating an information retrieval system, such as system 100 in FIG. 1. Flow chart 700 includes blocks 710-740, which are arranged and described serially. However, other embodiments execute two or more blocks in parallel using multiple processors or processor-like devices or a single processor organized as two or more virtual machines or sub processors. Other embodiments also alter the process sequence or provide different functional partitions or blocks to achieve analogous results. Moreover, still other embodiments implement the blocks as two or more interconnected hardware modules with related control and data signals communicated between and through the modules. Thus, the exemplary process flow applies to software, hardware, and firmware implementations.

At block 710, the exemplary method begins with provision of a multilingual document collection—that is a collection comprising two or more documents written in two or more languages. In the exemplary embodiment, the document collection takes the form of one or more databases, such as database 110 in FIG. 1. Execution continues at block 720.

Block 720 entails defining or extracting relationships between documents in the databases. In the exemplary embodiment, this entails using data-extraction module 124 in system 100 to extract specified data from the documents and using various techniques to identify or infer relationships between the extracted data. After the one or more indices are defined, processing continues at block 730.

Block 730 entails receiving a query (or trend report request) from a user. In the exemplary embodiment, this entails a user directing a browser in a client access device, such as device 130 in FIG. 1, to an internet-protocol (IP) address for an online information-retrieval system, such as system 100, and then logging onto the system using appropriate credentials. Successful login results in a web-based search interface, such as interface 138 in FIG. 1 (or one or more portions thereof) being output from server 120, stored in memory 132, and displayed by client access device 130. The user then defines the query by interacting with the interface, specifically entering data into one or more query fields or selecting from various drop down menus, and then transmits the query to a server, such as server 120 for processing. Execution then advances to block 740 (as shown in FIG. 7.)

Block 740 entails presenting a graphical user interface incorporating the data based on the request or query.

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

What is claimed is:

1. An information retrieval system comprising:
retrieval means for gathering intellectual property metadata based on a user query and a predetermined set of databases; and
report-generation means for generating and rendering reports regarding a set of intellectual property activities based on the user query.

2. The system of claim 1, further comprising: means for storing user preferences related to report generation; and wherein the report-generation means is responsive to the one or more of the stored user preferences to alter its generation of one or more reports.

3. The system of claim 1, further comprising graphical means for controlling access to stored user reports, the graphical means including first, second, and third portions, with the first portion including one or more control features for causing retrieval and display of a company patents; the second portion including one or more control features for causing retrieval and display of a law firm patent report; and the third portion including one or more control features for causing retrieval and display of an attorney patents report.

4. The system of claim 3, wherein the graphical means further includes a fourth portion having one or more control features for causing retrieval and display of a inventor patent report.

5. The system of claim 4, wherein each of the control features for causing retrieval and display is associated with indicia indicating when its associated report was last viewed by the user.

6. The system of claim 1, wherein the report-generation means includes means for generating a report by industry.

7. The system of claim 1, wherein the means for generating and rendering reports, includes means for selecting and initiating one of a set of two or more predefined queries of one or more intellectual property databases.

8. The system of claim 7, wherein the one of the set of predefined queries includes a predefined industry query of patent data or a predefined industry query of trademark data.

9. The system of claim 7, wherein the means for generating and rendering reports, includes first means for selecting and initiating a trademark search and second means for selecting and initiating a patent search, with the first and second means displayed simultaneously.

10. A method comprising:
retrieving intellectual property (IP) metadata based on a user query and a predetermined set of databases; and
generating and rendering at least one report regarding a set of intellectual property activities based on the user query.

11. The method of claim 10, further comprising: storing user preferences related to report generation; and wherein generating and rendering the at least one report includes altering the generation of the report based on the one or more of the stored user preferences.

12. The method of claim 10, further comprising:
storing one or more IP reports for retrieval by a user; and
controlling access to the stored user reports via a graphical interface including first, second, and third portions, with the first portion including one or more control features for causing retrieval and display of a company patents; the second portion including one or more control features for causing retrieval and display of a law firm patent report; and the third portion including one or more control features for causing retrieval and display of an attorney patents report.
